(19) United States
(12) Patent Application Publication
(10) Pub. No.: US 2021/0371994 A1
(43) Pub. Date: Dec. 2, 2021

(54) ORDERED ARRAY OF ONE DIMENSIONAL IRON OXIDE NANOSTRUCTURES

(71) Applicant: KING ABDULLAH UNIVERSITY OF SCIENCE AND TECHNOLOGY, Thuwal (SA)

(72) Inventors: Jürgen KOSEL, Thuwal (SA); Julian Alberto MORENO, Thuwal (SA)

(21) Appl. No.: 17/041,755

(22) PCT Filed: Apr. 4, 2019
(86) PCT No.: PCT/IB2019/052769

§ 371 Date: Sep. 25, 2020

Related U.S. Application Data
(60) Provisional application No. 62/653,969, filed on Apr. 6, 2018.

(51) Int. Cl. C25B 11/077; C25B 1/04; C25B 1/55; C25B 9/17; C25B 11/087

(52) U.S. Cl. CPC C25B 11/077; C25B 1/04; B82Y 40/00; C25B 9/17; C25B 11/087; C25B 1/55

(57) ABSTRACT

A method for forming an ordered array of one-dimensional iron oxide nanostructures involves forming an electrode on a template and forming a plurality of one-dimensional iron nanostructures in the template. A portion of the template is at least partially removed to expose a portion of each of the plurality of one-dimensional iron nanostructures. The plurality of one-dimensional iron nanostructures are annealed while the portion of each of the plurality of one-dimensional iron nanostructures is exposed to form an ordered array of iron-oxide one-dimensional nanostructures. The at least partial removal of the portion of the template involves complete removal of the template or a partial removal so that top portion of each of the plurality of one-dimensional iron nanostructures is exposed and a bottom portion of each of the plurality of one-dimensional iron nanostructures is within the template during annealing.

### CROSS-REFERENCE TO RELATED APPLICATIONS

This application claims priority to U.S. Provisional Patent Application No. 62/653,969, filed on Apr. 6, 2019, entitled “METHOD FOR PRODUCING IRON-OXIDE NANOWIRES,” the disclosure of which is incorporated herein by reference in its entirety.

### BACKGROUND

### Technical Field

Embodiments of the subject matter disclosed herein generally relate to a semiconductor device including an ordered array of one-dimensional iron oxide nanostructures, and method of production.

### Discussion of the Background

The impact of carbon emissions on the environment has led to increasing investment and research in alternatives to fossil fuels for energy production. One alternative is the generation of hydrogen by water splitting, which involves water oxidation and water reduction. Early attempts to make hematite electrodes for water oxidation focused on planar geometries, and the related surface and bulk properties of these have been extensively studied. These studies have resulted in a set of design criteria with the goal of maximizing the electrode's water oxidation performance.

Research has shown that one of the most important design criteria is nanostructuring because it enhances light absorption and reduces the distance the charge carriers have to traverse before being collected and moved to a counter electrode. The interaction of light with ordered arrays of nanostructures results in resonance effects in both the material and voids, which enhances charge carrier generation and results in increased water oxidation efficiency. Research has also shown that the surface properties of nanostructure hematite electrodes is strongly dependent on the patterning, material growth, and annealing techniques.

However, nanostructured hematite electrodes are typically produced with very little control over the ordering of the hematite nanostructures. For example, most nanowire arrays, having aspect ratios above 100, are grown in a grass-like disordered fashion, which quenches resonant interactions of electromagnetic fields with the structure. Further, the high aspect ratio of the nanowires increases the distance that the charge carriers have to traverse before they are collected by a metal, which greatly reduces performance.

One technique for forming iron nanowires is to form the iron nanowires in a template. The iron nanowires then need to be oxidized by annealing. This is typically performed either while the iron nanowires are in the template, or with the iron nanowires completely detached from the electrode and released from the template. The former hinders the oxidation process and negatively impacts the crystallinity of the oxidized iron nanowires, and the latter makes it difficult to integrate the iron-oxide nanowires into devices for they are not electrically connected to any substrate and individual manipulation is unmanageable. In either case, the resulting hematite iron-oxide nanowires are arranged in a grass-like disordered fashion.

Thus, there is a need for methods for producing iron-oxide nanowire in ordered arrays that does not suffer from poor crystallinity.

### SUMMARY

According to an embodiment, there is a method that involves forming an electrode on a template and forming a plurality of one-dimensional iron nanostructures in the template. A portion of the template is at least partially removed to expose a portion of each of the plurality of one-dimensional iron nanostructures. The plurality of one-dimensional iron nanostructures are annealed while the portion of each of the plurality of one-dimensional iron nanostructures is exposed to form an ordered array of iron-oxide one-dimensional nanostructures. The at least partial removal of the portion of the template comprises complete removal of the template or a partial removal so that a top portion of each of the plurality of one-dimensional iron nanostructures is exposed and a bottom portion of each of the plurality of one-dimensional iron nanostructures is within the template during annealing.

According to another embodiment, there is a semiconductor device comprising a substrate, a metallic electrode arranged on top of the substrate, and an ordered array of iron-oxide nanostructures attached to and rising from the metallic electrode.

According to a further embodiment, there is a water splitting device comprising a counter electrode, a voltage source electrically coupled to the counter electrode, and a working electrode electrically coupled to the counter electrode via the voltage source. The working electrode comprises a substrate, a metallic electrode arranged on top of the substrate, and an ordered array of one-dimensional iron-oxide nanostructures attached to and rising from the metallic electrode.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A is a flow diagram of a method for forming an ordered array of iron-oxide nanostructures according to embodiments;

FIG. 1B is a flow diagram with more details of the method for forming an ordered array of iron-oxide nanostructures according to embodiments;

FIGS. 2A-2F are schematic diagrams of a method for forming an ordered array of iron-oxide nanostructures according to embodiments;

FIG. 3A is a top view image of an ordered array of iron nanowires and FIG. 3B is a top view image of an ordered array of iron-oxide nanowires formed from the ordered array of iron nanowires of FIG. 3A when annealed at 350° C. for two hours according to embodiments;

FIG. 3C is a top view image of an ordered array of iron nanowires and FIG. 3D is a top view image of an ordered array of iron-oxide nanowires formed from the ordered array of iron nanowires of FIG. 3C when annealed at 450° C. for two hours according to embodiments; and

FIG. 4 is a schematic diagram of a water splitting device including an electrode having an ordered array of iron-oxide nanowires according to embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of iron-oxide one-dimensional nanostructures.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

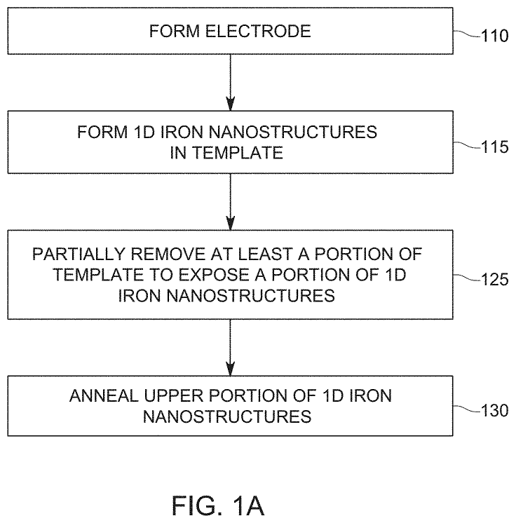

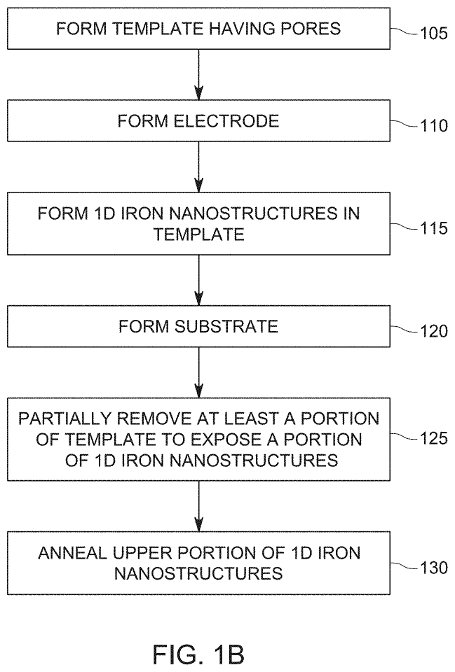

FIG. 1A is a flow diagram of a method for forming an ordered array of iron-oxide nanostructures according to embodiments. Initially, an electrode is formed on the bottom of a template (step 110). Next, a plurality of one-dimensional iron nanostructures are formed in the template (step 115). At least a portion of the template is removed to expose a portion of each of the plurality of one-dimensional iron nanostructures (step 125). The plurality of one-dimensional iron nanostructures are annealed while the portion of each of the plurality of one-dimensional iron nanostructures is exposed to form an ordered array of iron-oxide one-dimensional nanostructures (step 130). The at least partial removal of the portion of the template 205 comprises complete removal of the template 205 or a partial removal so that a top portion of each of the plurality of one-dimensional iron nanostructures is exposed and a bottom portion of each of the plurality of one-dimensional iron nanostructures is within the template during annealing. As used herein, an ordered array of iron-oxide one-dimensional nanostructures means that there is a pattern of specific inter-nanostructure distance and nanostructure location across an area, such as an electrode or substrate. The one-dimensional nanostructures can be nanowires or nanorods, depending upon the aspect ratio of the template pore in which the one-dimensional nanostructures are formed.

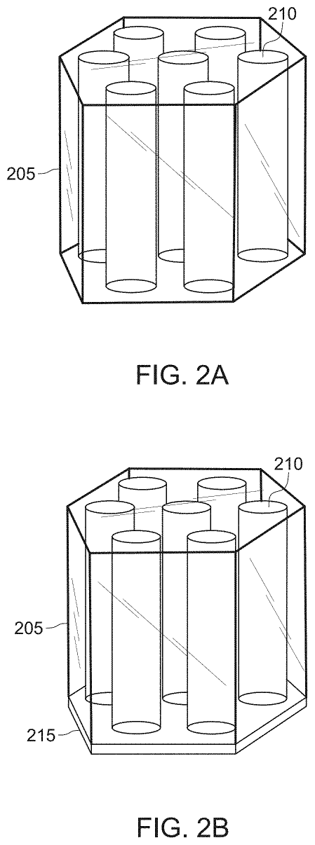

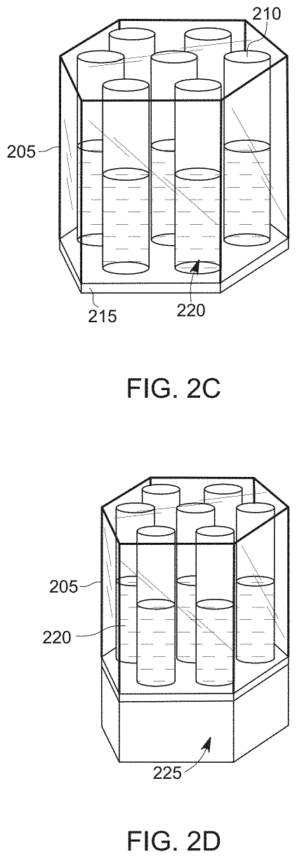

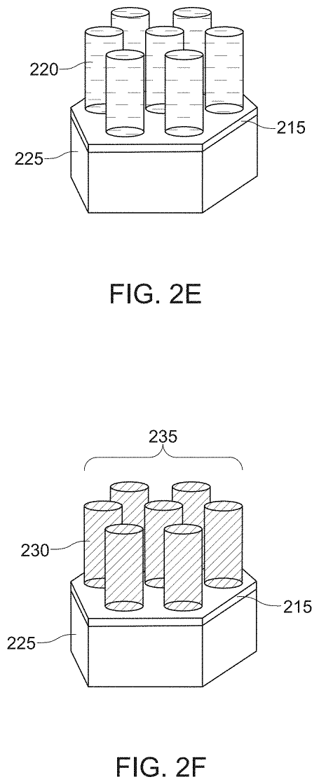

Additional details of the method for forming an ordered array of iron-oxide nanostructures will now be provided in connection with FIGS. 1B and 2A-2F. Turning first to FIG. 2A, a template 205 having pores 210 is formed (step 105). The pores 210 have a pattern of specific inter-pore distance and pore location across the template 205. The template 205 can be produced by, for example, by providing a metallic template, anodizing the metallic template and forming the plurality of pores. In one example, the template can comprise aluminum and the anodization can be achieved using oxalic acid to produce an alumina template.

Turning to FIG. 2B, an electrode 215 is formed on the bottom of the template 205 (step 110). The electrode 215 can be, for example, a gold electrode formed using sputter deposition techniques. The electrode 215 will act as a working electrode for the subsequent electroplating to form a substrate for the one-dimensional iron nanostructures. The one-dimensional iron nanostructures 220 (only one of which is labeled in the figure) are then formed in the pores 210 of the template 205 by electroplating (step 115 and FIG. 2C). As will be appreciated from FIG. 2C, the one-dimensional iron nanostructures 220 occupy less than the entire length of the pores 210. For example, in an embodiment the template 205 can be 60 μm high and nanorods are less than 1 μm high or nanowires are between 1 and 10 μm high.

A substrate 225 is then formed on the bottom of the electrode 215 (step 120 and FIG. 2D). In one example, the substrate 225 comprises nickel and is formed by electroplating using the metallic electrode 215 as the working electrode. The metallic electrode 215 and substrate 225 provide mechanical support for the one-dimensional iron nanostructures. At least a portion of the template 205 is removed to expose a portion of each of the one-dimensional iron nanostructures 220 (step 125 and FIG. 2E). The amount of template 205 that is removed can be selected to optimize the stability of the one-dimensional iron nanostructures (i.e., maintaining the nanostructures in an ordered array) versus the enhancement achieved by exposing portions of the one-dimensional iron nanostructures for the subsequent annealing process. For example, for a 1 μm high nanorod in a 60 μm high template, more than 98% of the template can be removed, and for a 1-10 μm high nanowire in a 60 μm high template, more than 83% of the template can be removed. Experimentation demonstrated that removing approximately 90% of the template provides both stability to the one-dimensional iron nanostructures and achieves the advantages of sufficient exposure of the one-dimensional nanostructures for subsequent annealing.

The plurality of one-dimensional iron nanostructures 220 are then annealed while a portion of each of their nanostructures is exposed to form an ordered array 235 of iron-oxide one-dimensional nanostructures 230 (step 130). Annealing the one-dimensional iron nanostructures 220 while a portion is exposed allows the oxidation process during the annealing to proceed unimpeded on the exposed portions, which results in the iron-oxide nanowires. It also provides more control over the oxidation process, allowing the generation of core/shell structures with an iron core and an iron oxide shell. The resulting semiconductor device comprises at least a substrate 225, a metallic electrode 215 arranged on top of the substrate, and an ordered array 235 of iron-oxide nanostructures 230 attached to and rising from the metallic electrode 215.

Although the method of FIGS. 1B and 2A-2F are described as both forming an electrode 215 and at least partially removing a portion of the template 205, the method can completely remove the template because the plurality of one-dimensional iron nanostructures are maintained in an ordered array due to the physical attachment to the electrode 215 and mechanical support from substrate 225. Alternatively, the substrate 225 can be omitted and only a portion of the template 205 is removed so that an upper portion of each of the plurality of one-dimensional nanostructures are exposed and a lower portion of each of the plurality of one-dimensional nanostructures is in the template. Because, in this alternative, the lower portion of each of the plurality of one-dimensional nanostructures is in the template while annealing, the plurality of one-dimensional iron nanostructures are maintained in an ordered array.

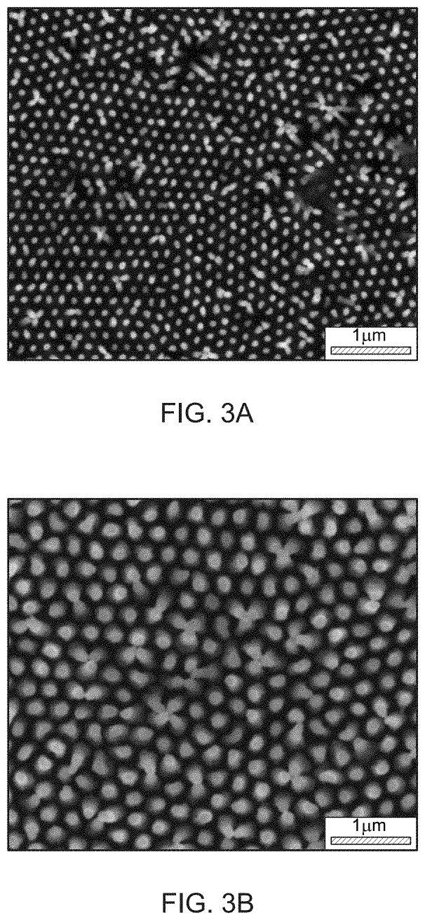

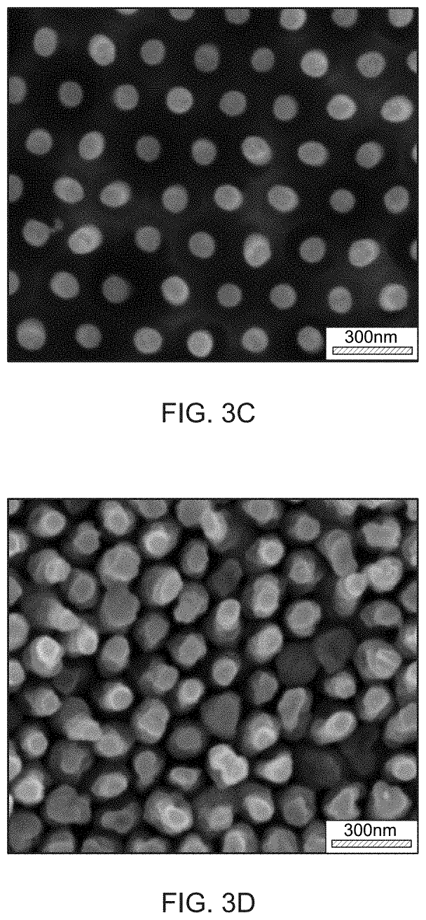

FIG. 3A is a top view image of an array of one-dimensional iron nanorods and FIG. 3B is a top view image of those nanorods after annealing at 350° C. for two hours, at which point the nanorods have a hematite/magnetite mixed phase. As will be appreciated by comparing the two photographs, the iron-oxide nanorods in FIG. 3B maintain the same general ordered array as the one-dimensional iron nanorods in FIG. 3A. FIG. 3C is a top view image of an array of one-dimensional iron nanorods and FIG. 3D is a top view image of those nanorods after annealing at 450° C. for two hours, at which point the nanorods have a hematite phase. As will be appreciated by comparing the two photographs, the iron-oxide nanorods in FIG. 3D maintain the same general ordered array as the one-dimensional iron nanorods in FIG. 3C. The 450° C. annealing temperature is significantly lower than what has been previously reported in connection with annealing iron nanorods to form hematite phase iron-oxide nanorods. This lower temperature to obtain hematite phase on the nanorods was due to the low volume of each rod, which allowed for an efficient thermal treatment. Experiments also revealed that an ordered array of magnetite phase iron-oxide nanorods can be achieved when annealing at 250° C. for two hours, and that at 550° C. the nanorods start to sinter and form a flatter unstructured surface.

Nanorods after annealing at 350° C. and 450° C. for two hours were evaluated and it was found that the very edge of the nanorods exhibited Fe2+ valence bands, whereas the edge's contribution from Fe3+ is higher. This may be due to the presence of chromium from the alumina template etching, which has a higher affinity to oxygen than iron. Although the nanorods in FIGS. 3B and 3D were annealed at a temperature to achieve a hematite phase, the nanorods can be annealed at a lower temperature (250° C.) to achieve a magnetite phase.

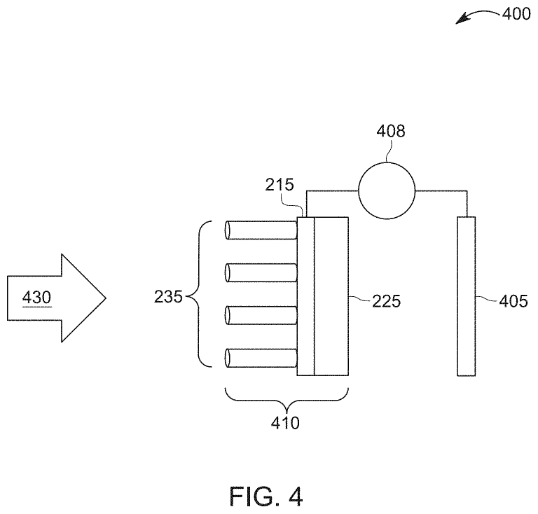

FIG. 4 illustrates a water splitting device 400 according to embodiments. The water splitting device includes a counter electrode 405, a working electrode 410 electrically coupled to the counter electrode 405 via a voltage source 408 so as to apply a constant bias between them. The voltage source 408 can be any type of voltage source, including, for example, a solar panel. The working electrode 410 comprises a substrate 225, a metallic electrode 215 arranged on an upper surface of the substrate, and an ordered array of one-dimensional iron-oxide nanostructures 235 attached to and rising from the metallic electrode 215. Thus, when the water splitting device 400 is submerged in water, sunlight 430 impinging upon the array of one-dimensional iron-oxide nanostructures 235 results in a photochemical reaction that causes water splitting. Because the one-dimensional iron-oxide nanostructures are arranged in an ordered array, there is more nanostructure surface area that can be exposed to the sunlight 430, which results in a more efficient water splitting process compared to flat surfaces or nanostructures formed in a grass-like fashion.

Because the disclosed methods for making an ordered array of one-dimensional nanorods employs a template, the method is highly customizable in terms of geometry (e.g., pore geometry, such as modulating a diameter of the pore along the length of the pore), materials, doping (which can occur during electroplating), and multisegments (i.e., a nanowire or nanorod comprised of segments of different compositions along its length, e.g., iron, gold, nickel, cobalt).

The disclosed embodiments provide an ordered array of one-dimensional iron-oxide nanostructures. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method, comprising:
forming an electrode on a template;
forming a plurality of one-dimensional iron nanostructures in the template;
at least partially removing a portion of the template to expose a portion of each of the plurality of one-dimensional iron nanostructures;
annealing the plurality of one-dimensional iron nanostructures while the portion of each of the plurality of one-dimensional iron nanostructures is exposed to form an ordered array of iron-oxide one-dimensional nanostructures,
wherein the at least partial removal of the portion of the template comprises complete removal of the template or a partial removal so that a top portion of each of the plurality of one-dimensional iron nanostructures is exposed and a bottom portion of each of the plurality of one-dimensional iron nanostructures is within the template during annealing.

2. The method of claim 1, further comprising:
forming the template having a plurality of pores, wherein the plurality of one-dimensional iron nanostructures are formed in the plurality of pores and the metallic electrode is formed on a bottom surface of the template.

3. The method of claim 2, wherein the pores have a pattern of specific inter-pore distance, pore geometry and pore location across the template.

4. The method of claim 2, wherein the formation of the template comprises:
providing a metallic template; and
anodizing the metallic template and forming the plurality of pores.

5. The method of claim 4, wherein the plurality of pores are formed having a size so that the one-dimensional iron nanostructures are nanorods.

6. The method of claim 4, wherein the plurality of pores are formed having a size so that the one-dimensional iron nanostructures are nanowires.

7. The method of claim 2, further comprising:
forming a substrate on a bottom of the metallic electrode after the plurality of iron nanostructures are formed in the template, wherein the electrode is interposed between the bottom of the template and the substrate.

8. The method of claim 1, wherein the annealing is performed at a temperature to form magnetite phased iron-oxide one-dimensional nanostructures.

9. The method of claim 1, wherein the annealing is performed at a temperature to form hematite phased iron-oxide one-dimensional nanostructures.

10. A semiconductor device, comprising:
a substrate;
a metallic electrode arranged on top of the substrate; and
an ordered array of iron-oxide nanostructures attached to and rising from the metallic electrode.

11. The semiconductor device of claim 10, further comprising:
a template arranged on top of the metallic electrode, wherein the template covers a bottom portion of each of the plurality of one-dimensional iron nanostructures and leaves exposed a top portion of each of the plurality of one-dimensional iron nanostructures.

12. The semiconductor device of claim 10, wherein the iron-oxide nanostructures are nanorods.

13. The semiconductor device of claim 10, wherein the iron-oxide nanostructures are nanowires.

14. The semiconductor device of claim 10, wherein the iron-oxide nanostructures have a magnetite phase.

15. The semiconductor device of claim 10, wherein the iron-oxide nanostructures have a hematite phase.

16. A water splitting device, comprising:
a counter electrode;
a voltage source electrically coupled to the counter electrode; and
a working electrode electrically coupled to the counter electrode via the voltage source, the working electrode comprising
a substrate;
a metallic electrode arranged on top of the substrate; and
an ordered array of one-dimensional iron-oxide nanostructures attached to and rising from the metallic electrode.

17. The water splitting device of claim 16, wherein the iron-oxide nanostructures are nanorods.

18. The water splitting device of claim 16, wherein the iron-oxide nanostructures are nanowires.

19. The water splitting device of claim 16, wherein the iron-oxide nanostructures have a magnetite phase.

20. The water splitting device of claim 16, wherein the iron-oxide nanostructures have a hematite phase.
